(19) United States
(12) Patent Application Publication
(10) Pub. No.: US 2017/0200962 A1
(43) Pub. Date: Jul. 13, 2017

(54) NANOCOMPOSITE MEMBRANE COMPRISING POLYHEDRAL OLIGOMERIC SILSESQUIOXANE HAVING SULFONIC ACID GROUPS AND METHOD FOR MANUFACTURING THE SAME

(71) Applicant: SOGANG UNIVERSITY RESEARCH FOUNDATION, Seoul (KR)

(72) Inventors: Heewoo RHEE, Seoul (KR); Sangwoo KIM, Seoul (KR); Taeyung YOUN, Gwangmyeong-si (KR)

(21) Appl. No.: 15/324,726

(22) PCT Filed: Jul. 2, 2015
(86) PCT No.: PCT/KR2015/006810

§ 371 Date: Jan. 8, 2017

(30) Foreign Application Priority Data
Jul. 9, 2014 (KR) 10-2014-0085839

(51) Int. Cl. H01M 8/1051; H01B 1/12; H01M 8/1025; B01J 39/19; C08J 5/22

(52) U.S. Cl. CPC H01M 8/1051; B01J 39/19; C08J 5/2275; H01M 8/1025; H01B 1/12; C08J 2371/10; C08J 2381/06; H01M 2008/1095

(57) ABSTRACT

The present invention relates to a sulfonated polyetheretherketone (sPEEK) nanocomposite film containing silsesquioxane and exhibiting excellent proton conductivity and mechanical strength, and a method for manufacturing the same. The nanocomposite film of the present invention has excellent conductivity since multiple sulfonic acid groups as a proton source exist in POSS used as a filler. In addition, the POSS used in the present invention is very small, having a size of 1-2 nm, and thus hardly obstructs the migration of protons in the ion channel in the polymer membrane, thereby realizing excellent proton conductivity. In addition, the proton conductive nanocomposite film by the present invention shows excellent mechanical strength even though the degree of sulfonation of sulfonated polyetheretherketone is increased.

### TECHNICAL FIELD

The present invention relates to a sulfonated polyetheretherketone nanocomposite membrane comprising a silsesquioxane with a sulfonic acid group and a method of preparing the same. More particularly, the present invention relates to a sulfonated polyetheretherketone nanocomposite membrane comprising a silsesquioxane exhibiting excellent proton conductivity and mechanical strength and a method of preparing the same.

### BACKGROUND ART

Fuel cells, recently spotlighted, are generation systems that convert the energy generated from electrochemical reaction between fuel and oxidant directly into electrical energy. Due to increase of environmental problems, depletion of energies and commercialization of fuel cell vehicles, various polymeric membranes applicable to high temperature are being widely developing.

Fuel cells are classified into a molten carbonate electrolyte fuel cell operating at high temperatures (500-700° C.), a phosphate electrolyte fuel cell operating around 200° C., an alkaline electrolyte fuel cell operating at room temperature to about 100° C. and a polymer electrolyte fuel cell, etc.

Among these, polymer electrolyte fuel cells are environmentally friendly and have a high power density and energy conversion efficiency. Their advantages are the possibility to operate at room temperature and to miniaturize and seal a polymer electrolyte fuel cell. Thus, this is widely applicable to non-polluting cars, home generation systems, mobile telecommunication equipment, medical devices, military equipment and aerospace equipment among others. Consequently, current research is increasingly focused on polymer electrolyte fuel cells.

Among these a proton exchange membrane fuel cell (PEMFC) utilizing hydrogen gas as fuel produces DC electricity from an electrochemical reaction between hydrogen and oxygen, and has a structure where a 50-200 μm-thick proton conductive polymer membrane is inserted between an anode and a cathode. A hydrogen molecule is decomposed to a hydrogen ion and an electron by an oxidation reaction at the anode as hydrogen gas is being supplied as a reacting gas. At this time, a reduction reaction in which an oxygen molecule accepts electrons to become oxygen ions occurs when the hydrogen ion is transferred to the cathode through the proton conductive polymer membrane. The generated oxygen ion then reacts with the hydrogen ions transferred from the anode to become a water molecule.

In this process, the proton conductive polymer membrane is electrically isolated but acts as a medium that transfers hydrogen ions from the anode to the cathode during cell operation and simultaneously separates liquid or gas fuel from the oxidant gas. Thus, the membrane should have excellent mechanical property, electrochemical stability and thermal stability at the operating temperature. In addition, it is required that the membrane be fabricated as a thin film in order to reduce friction and not expand much when containing liquid.

The conventional electrolytic membrane that has been widely used to polymer electrolyte fuel cells is Nafion developed by Du Pont. Although, Nafion has good proton conductivity (0.1 S/cm), however, it has critical disadvantages of poor strength and under-performance at conditions of low humidity, for example, above 100° C. It is known that the disadvantages are due to the ion conduction mechanism of the sulfonic acid group contained in the Nafion.

Korean Patent Registration No. 10-804195 suggests a high temperature-type proton ion conductive polymer electrolyte membrane having high conductivity at high temperatures. This is achieved by introducing a sulfonic group into an inorganic nanoparticle and combining it with a polymer electrolyte to form a composite. However, this composite membrane has the disadvantage of low proton conductivity due to inorganic particles having the size of several hundred nanometers hindering proton transport. In addition, the mechanical strength of the composite membrane is lowered owing to the size and aggregation of the inorganic particles.

Korean Patent Application Publication No. 10-2013-118075 authored by the present inventors discloses a composite membrane comprising a fluorine-based proton conductive polymer, such as Nafion, mixed with a silsesquioxane. According to the cited patent, the mechanical strength and conductivity of the electrolyte membrane is enhanced by using silsesquioxane particles only several nanometers in size. However, disadvantages connected to Nafion such as high production cost, long-term decrease of conductivity during service, rapid decrease in performance above 80° C. still exist.

### SUMMARY OF DISCLOSURE

### Technical Problem

The object of the present invention is to provide a proton conductive polymer membrane exhibiting high proton conductivity and good mechanical strength at medium or low temperatures below 100° C.

### Technical Solution

One aspect of the invention relates to a proton conductive nanocomposite membrane comprising an aromatic hydrocarbon polymer membrane having a sulfone group, mixed with a polyhedral oligomeric silsesquioxane (POSS) having a sulfonic acid group.

Another aspect of the invention relates to a method of preparing a proton conductive nanocomposite membrane comprising: mixing an aromatic hydrocarbon polymer solution having a sulfone group with a polyhedral oligomeric silsesquioxane (POSS) solution; and casting the mixed solution and then removing the solvent.

Yet another aspect of the invention relates to a membrane electrode assembly for a fuel cell comprising a proton conductive nanocomposite membrane.

### Advantageous Effects

The nanocomposite membrane of the present invention has POSS used as a filler and a plurality of sulfonic acid groups acting as proton sources. Thus, it exhibits excellent conductivity. Additionally, the POSS employed in the present invention is as small as 1-2 nm in size and, thus, does not hinder proton transport within the ion channel of the polymer membrane to sustain excellent proton conductivity.

Moreover, the proton conductive nanocomposite membrane of the present invention shows excellent mechanical strength in spite of the high degree of sulfonation of the polymer membrane.

### BRIEF DESCRIPTION OF DRAWINGS

FIG. 1 shows results of ion conductivity measurements of the conductive nanocomposite membranes prepared in Example 1 and Comparison example 1.

FIG. 2 shows the results of ion conductivity measurements of the conductive nanocomposite membranes prepared in Example 2 and Comparison example 1.

FIG. 3 shows the results of tensile strengths measurements of the conductive nanocomposite membranes prepared in Example 1 and Comparison example 1.

FIG. 4 shows the cell test results of the cells prepared in Example 3 and Comparison example 2.

### DETAILED DESCRIPTION—BEST MODE

The present invention will be described in detail as follows.

The present invention relates to a proton conductive polymer nanocomposite membrane for a fuel cell. The proton conductive nanocomposite membrane of the present invention is prepared by mixing an aromatic hydrocarbon polymer membrane having sulfone groups with a polyhedral oligomeric silsesquioxane (POSS) having sulfonic acid groups.

The nanocomposite membrane of the aromatic hydrocarbon polymer membrane having a sulfone group may be a sulfonated polyetheretherketone (sPEEK) polymer membrane, a sulfonated polyetherketone (sPEK), a sulfonated polyethersulfone (sPES), or a sulfonated polyarylethersulfone (sPAES).

An aromatic hydrocarbon polymer containing sulfonic acid groups as a proton source may be used for the polymer membrane of the present invention.

The aromatic hydrocarbon polymer containing sulfonic acid groups, preferably, polyetheretherketone and polyethersulone, has excellent proton conductivity and thermal/chemical properties that are comparable to a Nafion membrane and good durability up to 300 hours of service.

The aromatic hydrocarbon polymer containing sulfonic acid groups generally shows excellent proton conductivity as its degree of sulfonation (DS) increases, whereas its durability (long-term stability) and mechanical strength decreases due to the increase of OH radicals and increase of swelling. However, according to the present invention, conductivity as well as mechanical strength of the membrane increased in spite of using an aromatic hydrocarbon polymer with a high degree of sulfonation.

The degree of sulfonation of the sulfonated aromatic hydrocarbon polymer membrane may be 55%-80%, preferably 60%-70%, more preferably 60%-65%, and most preferably about 65%. When the nanocomposite membrane is prepared at a degree of sulfonation ranging from 60% to 70%, the conductivity is highest at 1.5 wt %. In addition, when the DS is 65%, the conductivity is high without water swelling. When the DS of the nanocomposite membrane is more than 70%, its conductivity rapidly increases, but its mechanical strength is lowered due to water swelling of the membrane.

According to the present invention, a polyhedral oligomeric silsesquioxane (POSS) having sulfonic acid groups is used as a filler for the sulfonated aromatic hydrocarbon polymer membrane.

The polyhedral oligomeric silsesquioxane (POSS) may have the following formula 1,

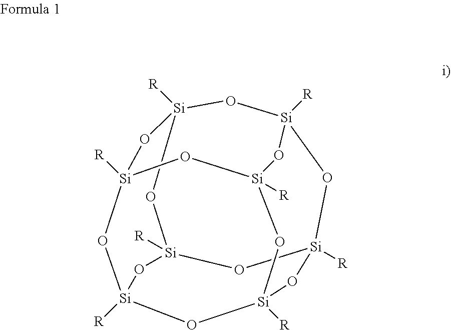

where R is selected from a sulfonic acid group, a hydroxide group, a phenyl group, an alkyl group, a phenol group, an ester group, a nitrile group, an ether group, an aldehyde group, a formyl group, a carbonyl group or a ketone group; or

at least one R of the formula 1 is —R¹—SO₃H or —R²R³SO₃H, where R¹ is (CH₂)ₙ (n is an integer of 1-6) or phenylene, R² is O or (CH₂)ₙ (n is an integer of 1-6), and R³ is phenylene.

The polyhedral oligomeric silsesquioxane (POSS) may be preferably sulfonated octaphenyl polyhedral oligomeric silsesquioxane of the following formula 2,

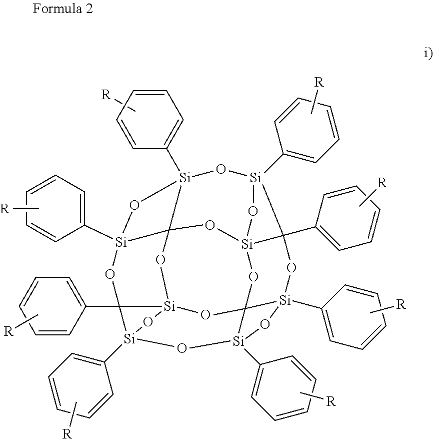

where at least one R of the formula 2 is —SO₃H.

The sulfonated polyhedral oligomeric silsesquioxane (POSS-SA) may have a particle size of 1-2 nm. The size of POSS-SA is small so that ion transport in the ion channel of sPEEK conductive membrane is not hindered. As such, the most problematic issue of decrease in conductivity may be solved.

The sulfonated polyhedral oligomeric silsesquioxane (POSS-SA) has a stable silica cage structure and excellent dispersibility in the membrane since the length and size of R of the formula 1 is short and small. Formula 2, in particular has a very compact chemical structure (no long hydrocarbon chains) where phenyl groups and sulfonic acid groups are bonded to the cage structure and therefore has a very small particle size which facilitates dispersion.

Accordingly, the ion conductivity and mechanical strength (strain and strength) of the nanocomposite membrane according to the present invention maintains or increases even though the content of the sulfonated polyhedral oligomeric silsesquioxane (POSS-SA) is increased to 10-20 wt %. This is because the POSS-SA does not aggregate much within the channels of the membrane.

In addition, the silica structure of the sulfonated polyhedral oligomeric silsesquioxane (POSS-SA) is hydrophobic in structure and thus, decreases the possibility of swelling. In addition, due to the high water retention ability of POSS-SA, conductivity can be maintained at high temperatures (80-100° C.).

Sulfonated polyhedral oligomeric silsesquioxane (POSS-SA) content in the nanocomposite membrane may be 1-20 wt %, preferably 1-10 wt %, and more preferably 1-5 wt %.

When sulfonated polyetheretherketone (sPEEK) polymer membrane is used as the polymer membrane, the sulfonated polyhedral oligomeric silsesquioxane (POSS-SA) content in the nanocomposite membrane may be most preferably, 1-2 wt %.

When the content of the POSS-SA is 1-2 wt %, the conductivity of the nanocomposite membrane of the present invention is more than that of the conventional Nafion membrane (0.12 S/cm) at 80° C./100% RH. However, in the case that the content of the POSS-SA is more than 2 wt %, the conductivity of the nanocomposite membrane may be decreased slightly due to blocking/aggregation of the POSS-SA in the ion channels.

Moreover, when the content of the POSS-SA is 1.5 wt % and the degree of sulfonation of the sulfonated polyetheretherketone (sPEEK) is 75%, the ion conductivity of the nanocomposite membrane is 0.138 S/cm, which is much higher than that of the Nafion membrane.

In the case that sulfonated polyarylethersulfone (sPAES) polymer membrane is used for the polymer membrane, the sulfonated polyhedral oligomeric silsesquioxane (POSS-SA) content of the nanocomposite membrane may be 2-5 wt %. In addition, when the POSS-SA content is 3 wt % and the degree of sulfonation of the sPAES is 80%, the ion conductivity of the nanocomposite membrane is 0.18 S/cm, which is much higher than that of the Nafion membrane.

According to the present invention, even though the polymer membranes had a degree of sulfonation of 55-80%, they were mechanically strong due to the POSS-SA particles forming a molecular composite structure within the polymer membrane at the molecular level.

That is, the conductivity and the mechanical strength of the proton conductive nanocomposite membrane may be simultaneously enhanced, according to the present invention.

Another aspect of the present invention relates to a method of preparing a proton conductive nanocomposite membrane.

The method comprises the steps of mixing an aromatic hydrocarbon polymer solution having a sulfone group with a polyhedral oligomeric silsesquioxane (POSS) solution; and casting the mixed solution followed by removing the solvent.

The aromatic hydrocarbon polymer solution having a sulfone group may be a sulfonated polyehteretherketone (sPEEK) polymer membrane, a sulfonated polyetherketone (sPEK), a sulfonated polyethersulfone (sPES), or a sulfonated polyarylethersulfone (sPAES).

According to the method, the degree of sulfonation of the aromatic hydrocarbon polymer membrane having a sulfone group may be controlled to 55% to 80%, and the content of polyhedral oligomeric silsesquioxane (POSS) in the mixture of the aromatic hydrocarbon polymer and the POSS may be controlled to 1 wt % to 20 wt %.

The sulfonated polyetheretherketone (sPEEK) may be prepared by any known method, for example, a synthetic method comprising adding a sulfonating agent to polyetheretherketone (PEEK) solution and heating the solution.

The sulfonating agent may be any compound such as sulfonic acid, among others, known in the art. The degree of sulfonation, in said sulfonation of PEEK may be controlled at reaction conditions of 60-150° C. and 1-30 hours. More particularly, PEEK is dried at 100° C. for 12 hours and, then, 10 g of PEEK is added to 200 mL of sulfuric acid, followed by stirring the solution at 60° C. for 24 hours.

Yet another aspect of the present invention relates to a membrane electrode assembly for a fuel cell comprising a fuel electrode; an oxygen electrode; and said proton conductive nanocomposite membrane placed in between an adjoining fuel electrode and an oxygen electrode.

The fuel electrode serves as an anode of a fuel cell and comprises a catalyst layer including electrode catalysts, and a gas diffusion layer. Hydrogen gas is introduced from outside, through the diffusion layer, into the fuel electrode and, then, protons are generated.

Typically, Pt or Pt—Ru catalyst is used as an electrode catalyst in the fuel electrode, and this is supported by a carbon-based supporter such as carbon black.

The oxygen electrode (also referred to as an “air electrode”) acts as a cathode of a fuel cell and comprises a catalyst layer including electrode catalysts, and a gas diffusion layer. Water is produced in the oxygen electrode by reaction of protons with electrons.

Typically, a Pt catalyst is used as an electrode catalyst in the oxygen electrode, and this is supported by carbon-based supporter such as carbon black.

The present invention also relates to a fuel cell comprising the aforementioned membrane electrode assembly.

A fuel cell according to one embodiment of the present invention may be prepared by any known method, using the above-mentioned membrane-electrode assembly. That is, as mentioned above, a unit cell may be fabricated by separating both ends of the membrane-electrode assembly via a metal separator and, then, a fuel cell stack may be produced by stacking the unit cells.

### Detailed Description—Mode for Invention

The following description of the preferred embodiment(s) is merely exemplary in nature and is in no way intended to limit the invention, its application, or uses.

### Example 1

1. Synthesis of POSS-PA

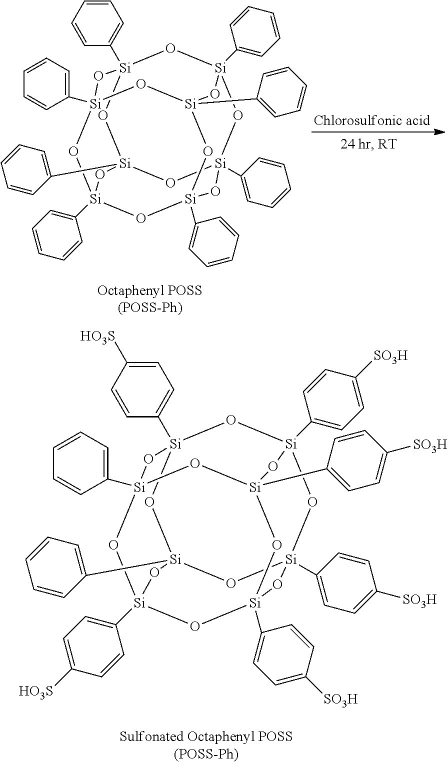 [SMILES: c1ccc([Si]23O[Si]4(c5ccccc5)O[Si]5(c6ccccc6)O[Si](c6ccccc6)(O2)O[Si]2(c6ccccc6)O[Si](c6ccccc6)(O3)O[Si](c3ccccc3)(O4)O[Si](c3ccccc3)(O5)O2)cc1 ; O=S(=O)(O)c1ccc([Si]23O[Si]4(c5ccccc5)O[Si]5(c6ccc(S(=O)(=O)O)cc6)O[Si](c6ccccc6)(O2)O[Si]2(c6ccc(S(=O)(=O)O)cc6)O[Si](c6ccc(S(=O)(=O)O)cc6)(O3)O[Si](c3ccc(S(=O)(=O)O)cc3)(O4)O[Si](c3ccc(S(=O)(=O)O)cc3)(O5)O2)cc1]

First, 1 g of octaphenyl POSS was mixed with 5 mL of chlorosulfonic acid and, then, the solution was stirred overnight at room temperature. The solution was then poured into 200 ml of THF, in which precipitates were filtered. This step was repeated until a neutral pH was reached. Brown-colored solids were obtained as a result of drying under reduced pressure.

H-NMR (D2O)-7.54 (dd; ArHmeta to POSS), 7.81-7.83 (2dd; ArH para to SO3H, ArHpara to POSS), 8.03 (dd; ArH ortho to SO3HandPOSS).

FT-IR: 3070 (OH of SO3H), 2330 (SO3H-H2O), 1718, 1590, 1470, 1446, 1395, 1298, 1132 (SO3 asym), 1081 (SO3 sym), 1023 (SiOSi asym), 991, 806 (SiOSi sym)

2. Preparation of Nanocomposite Membrane

5 g of sulfonated polyetheretherketone (sPEEK; DS=60, 70, 75; sPEEK of DS=60 was purchased from Fumatech and sPEEK of DS 70 and 75 were prepared from sPEEK of DS 60) was dissolved in 95 g of N,N-dimethylacetamide (DMAc) in a stirred oil bath at 90° C. to obtain 5 wt % solution.

11.76 g of the 5 wt % solution (0.588 g of sPEEK) was each stored in 4 separate vials, respectively. Then, 0.006 g, 0.009 g and 0.012 g of POSS-SA was dissolved in 30 mL of DMAc, respectively. Since POSS-SA does not easily dissolve in an organic solvent, the POSS-SA was agitated in distilled water and, then, dissolved in DMAc. The distilled water was removed therearfter.

The sPEEK solution and the POSS-SA solution were mixed and agitated for 1 day to obtain 0 wt %, 1 wt %, 1.5 wt % and 2 wt % sPEEK/POSS-SA solutions. The solutions were poured into a chalet, respectively, and were cast overnight in an oven at 100° C. After casting, distilled water was poured in the chalets and, thereafter, nanocomposite membraned were exfoliated carefully from the chalets. The membrane was then immersed into a 2M sulfuric acid solution for 1 hour and, then, immersed into boiling water in order to remove any organic solvent remaining in the nanocomposite membrane. Thereafter, proton conductive nanocomposite membranes were obtained.

### Example 2

1. The POSS-SA Prepared in Example 1 was Used.

2. Preparation of Nanocomposite Membrane

A nanocomposite membrane was prepared by the procedure of Example 1 except that 3 g of sulfonated polyarylethersulfone (sPAESK 2.0, sPAESK 1.8, of Korea Institute of Energy Research; DS=80) was used, and 0.006 g, 0.009 g and 0.012 g of POSS-SA was dissolved in 30 mL of DMAc.

### Comparison Example 1

A proton conductive polymer membrane was prepared by using only sulfonated polyetheretherketone (sPEEK, DS 60) without adding POSS-SA.

### Experiment: Measurement of Ion Conductivity

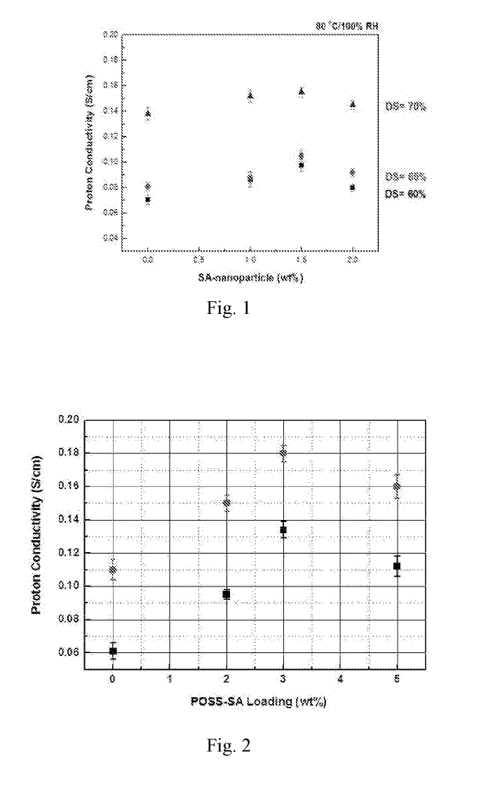

The thicknesses of the composite membranes obtained in Examples 1 and 2, and Comparison example 1 were measured. Thereafter, a 4 probe conductivity cell (Bekktech) was connected to an AC impedance bridge and the ion conductivities of said samples were measured at 80° C./100% RH. The ion conductivities measured are shown in FIG. 1 (sPEEK) and FIG. 2 (sPAESK), respectively.

### Experiment 2: Measurement of Tensile Strength

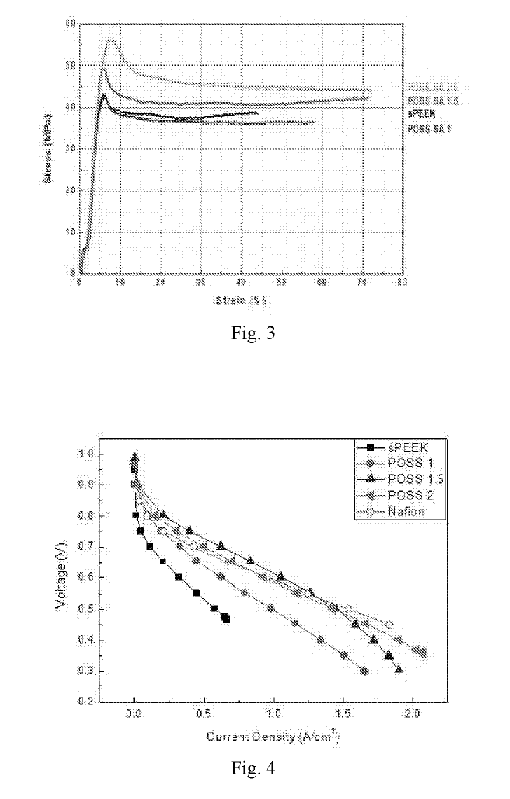

After drying the membranes of Example 1 and Comparison example 1, the mechanical strengths of the membranes were measured by using a UTM (universal testing machine) at room temperature according to ASTM d882 standard testing procedures. FIG. 3 shows the tensile strengths of the nanocomposite membranes of Example 1 and Comparison example 1.

### Example 3: Fabrication of Cell

A Pt/C electrode coated with 0.4 mg Pt/cm² was prepared. After cutting the Pt/C electrode into 5 squares (2.23 cm×2.23 cm), each electrode was applied with a 5 wt % Nafion dispersion using a brush. After the Nafion dispersion was completely dried, the nanocomposite membrane of Example 1 was inserted between PTFE-attached iron plates located between each electrode and, then, pressed under the force of 6 MPa for 10 min on a hot pressor set at 150° C. The obtained MEA (membrane-electrode assembly) was then assembled in to a cell.

### Comparison Example 2

A cell was prepared by the same procedure of Example 3, except for utilizing the polymer membrane of Comparison example 1.

### Comparison Example 3

A cell was prepared by the procedure of Example 3 except for using a conventional Nafion polymer membrane.

### Experiment 3: Cell Test

Cell tests were carried out by using the cells of Example 3 and Comparison example 2. After setting the temperature of the humidifier to 80° C., a gas of H₂:O₂=1.5:2 was introduced. Current density was measured under CV (current voltage) mode in the range of 1.0 V to 0.3 V in 0.25V incremental steps in reducing order.

Cell test results are shown in FIG. 4.

Referring to FIG. 1, the ion conductivity with the addition of POSS-SA nanoparticles was higher than that without the addition of POSS-SA. In addition, for the degrees of sulfonation (DS) given, the ion conductivity was the highest at 1.5 wt % of the POSS-SA content. The highest conductivity measured was 0.138 S/cm at the DS of 75%. When the DS exceeded 70%, the ion conductivity steeply increased but the mechanical strength decreased due to severe water swellings of the membrane. When the DS was 65%, the ion conductivity was high without water swelling.

With reference to FIG. 2, ion conductivity was higher when the POSS-SA contents were 1-5 wt % in sPAESK 2.0 and sPAESK 1.8 than when POSS-SA content was 0. The ion conductivities of the membrane were 0.15-0.18 S/cm, which is much higher than those generally known for the conventional Nafion membrane.

Referring to FIG. 3, the tensile strength of sPEEK without POSS-SA (Comparison example 1) is 42.7 MPa, whereas that of sPEEK/POSS-SA nanocomposite membrane shows that strength increased by about 33% when the content of POSS-SA was 2 wt %, in contrast to the case of Comparison example 1.

In addition, the strain of sPEEK was about 42% in contrast to 72% in the case of Example 1, indicating that the strain increased by almost 30%.

Referring to FIGS. 1-3, it can be understood that sPEEK and sPAESK with POSS-SA according to the present invention exhibited considerably enhanced conductivities as well as mechanical strengths, comparing to the conventional Nafion membrane and the sPEEK membrane.

Referring to FIG. 4, the current density of Example 3 (POSS 1.5, POSS 2) at 0.7 V was higher than that of Comparison example 2 or 3.

The preferred embodiments of the present invention have been disclosed and illustrated. However, the invention is intended to be as broad as defined in the claims below. Those skilled in the art may be able to study the preferred embodiments and identify other ways to practice the invention that are not exactly as described in the present invention. It is the intent of the inventor(s) that variations and equivalents of the invention are within the scope of the claims below and the description, abstract and drawings not to be used to limit the scope of the invention.

### INDUSTRIAL APPLICABILITY

The nanocomposite membrane of the present invention may be utilized in a membrane electrode assembly for a fuel cell since it exhibits excellent ion conductivity in ion channels within the polymer membrane.

1. A proton conductive nanocomposite membrane comprising an aromatic hydrocarbon polymer membrane having a sulfone group; mixed with a polyhedral oligomeric silsesquioxane (POSS) having a sulfonic acid group.

2. The nanocomposite membrane of claim 1, wherein the aromatic hydrocarbon polymer membrane having a sulfone group is a material selected from the group consisting of a sulfonated polyetheretherketone (sPEEK) polymer membrane, a sulfonated polyetherketone (sPEK), a sulfonated polyethersulfone (sPES), and a sulfonated polyarylethersulfone (sPAES).

3. The nanocomposite membrane of claim 1, wherein the aromatic hydrocarbon polymer membrane having a sulfone group has a degree of sulfonation of 55% to 80%.

4. The nanocomposite membrane of claim 1, wherein the nanocomposite membrane comprises 1 wt % to 20 wt % of the polyhedral oligomeric silsesquioxane (POSS).

5. The nanocomposite membrane of claim 1, wherein the polyhedral oligomeric silsesquioxane (POSS) has a particle size of 1 nm to 2 nm.

6. The nanocomposite membrane of claim 1, wherein the polyhedral oligomeric silsesquioxane (POSS) has the following formula; 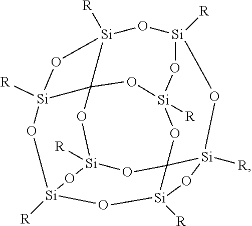
wherein R is a compound having a functional group selected from the group consisting of a sulfonic acid group, a hydroxide group, a phenyl group, an alkyl group, a phenol group, an ester group, a nitrile group, an ether group, an aldehyde group, a formyl group, a carbonyl group and a ketone group; or
at least one R of the formula is —R¹—SO₃H or —R²R³SO₃H, where R¹ is (CH₂)ₙ (n is an integer of 1-6) or phenylene, R² is O or (CH₂)ₙ (n is an integer of 1-6), and R³ is phenylene.

7. The nanocomposite membrane of claim 1, wherein the polyhedral oligomeric silsesquioxane (POSS) has the following formula; 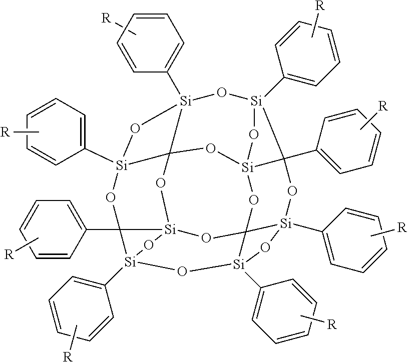
where at least one R of the formula is —SO₃H.

8. The nanocomposite membrane of claim 1, wherein the polyhedral oligomeric silsesquioxane (POSS) is a sulfonated octaphenyl polyhedral oligomeric silsesquioxane (POSS-SA).

9. A method of preparing a proton conductive nanocomposite membrane comprising the steps of:
mixing an aromatic hydrocarbon polymer solution having a sulfone group with a polyhedral oligomeric silsesquioxane (POSS) solution;
casting the mixed solution; and
removing a solvent.

10. The method of claim 9, wherein the aromatic hydrocarbon polymer membrane having a sulfone group is a material selected from the group consisting of a sulfonated polyetheretherketone (sPEEK) polymer membrane, a sulfonated polyetherketone (sPEK), a sulfonated polyethersulfone (sPES), and a sulfonated polyarylethersulfone (sPAES).

11. The method of claim 9, wherein the aromatic hydrocarbon polymer membrane having a sulfone group has a degree of sulfonation, which is controlled to 55% to 80%, and
wherein the polyhedral oligomeric silsesquioxane (POSS) content in the solution of the aromatic hydrocarbon polymer with the POSS is controlled to 1 wt % to 20 wt %.

12. The nanocomposite membrane according to claim 1, wherein the nanocomposite membrane is placed in between an adjoining fuel electrode and an oxygen electrode to form a membrane electrode assembly.

13. The membrane electrode assembly according to claim 12, wherein the membrane electrode assembly is operably installed in a fuel cell.

14. The nanocomposite membrane according to claim 2, wherein the nanocomposite membrane is placed in between an adjoining fuel electrode and an oxygen electrode to form a membrane electrode assembly.

15. The membrane electrode assembly according to claim 14, wherein the membrane electrode assembly is operably installed in a fuel cell.

16. The nanocomposite membrane according to claim 3, wherein the nanocomposite membrane is placed in between an adjoining fuel electrode and an oxygen electrode to form a membrane electrode assembly.

17. The membrane electrode assembly according to claim 16, wherein the membrane electrode assembly is operably installed in a fuel cell.

18. The nanocomposite membrane according to claim 4, wherein the nanocomposite membrane is placed in between an adjoining fuel electrode and an oxygen electrode to form a membrane electrode assembly.

19. The membrane electrode assembly according to claim 18, wherein the membrane electrode assembly is operably installed in a fuel cell.

20. The nanocomposite membrane according to claim 5, wherein the nanocomposite membrane is placed in between an adjoining fuel electrode and an oxygen electrode to form a membrane electrode assembly.
